(19) United States
(12) Patent Application Publication
(10) Pub. No.: US 2003/0076548 A1
(43) Pub. Date: Apr. 24, 2003

(54) Image capture device with stand

(76) Inventor: Nigel M-F Cheung, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/012,909

(22) Filed: Oct. 22, 2001

(51) Int. Cl. H04N 1/04

(52) U.S. Cl. 358/474

(57) ABSTRACT

An improved image capture device comprising an image capture device and a stand pivotally coupled to the image capture device is disclosed. The stand is operable to support the image capture device in a raised position.

### TECHNICAL FIELD OF THE INVENTION

The present invention relates generally to the field of image capture devices, and more particularly to an image capture device with a stand.

### BACKGROUND OF THE INVENTION

Image capture devices, including, but not limited to, optical flatbed scanners, printers, facsimile machines, photocopiers, and/or the like, are typically used to obtain a digital image of an object. Flatbed scanners generally include an imaging plate and a document lid. The imaging plate is typically a transparent platen upon which the object to be scanned is placed and the document lid is used to cover the imaging plate and the object. The document lid generally includes a document reflector which presses the document to be imaged flat against the imaging plate to provide a better image.

Generally, the scanner is placed in close proximity to other electronic equipment on a work surface. For example, the scanner may be coupled to a computer with a keyboard to allow manipulation of the scanned image. Furthermore, a printer may be coupled to the computer so that the scanned image may be printed. Other electronic equipment, such as a telephone, speakers, etc. may also be present in close proximity to the scanner. Thus, the work surface is frequently very crowded.

Existing image capture devices when in use are typically horizontally oriented along a work surface. Even when not in use, such image capture devices remain horizontally stowed and their footprints take up a significant amount of space on the work surface.

### SUMMARY OF THE INVENTION

In accordance with an embodiment of the present invention, an improved image capture device comprising an image capture device and a stand pivotally coupled to the image capture device is disclosed. The stand is operable to support the image capture device in a raised position.

In accordance with another embodiment of the present invention, an improved image capture device comprising an image capture device, a stand and a power switch is disclosed. The stand is pivotally coupled to the image capture device to facilitate storing of the image capture device in a raised position. The power switch is disposed on the image capture device such that when the image capture device is not in the raised position the power switch is in an ON position due at least in part to at least a portion of the stand interfacing with the power switch.

### BRIEF DESCRIPTION OF THE DRAWINGS

For a more complete understanding of the present invention, the objects and advantages thereof, reference is now made to the following descriptions taken in connection with the accompanying drawings in which:

FIGS. 1A-1E are different views of an image capture device according to a preferred embodiment of the present invention; and

FIGS. 2A-2D are different views of an image capture device according to an alternative embodiment of the present invention.

### DETAILED DESCRIPTION OF THE DRAWINGS

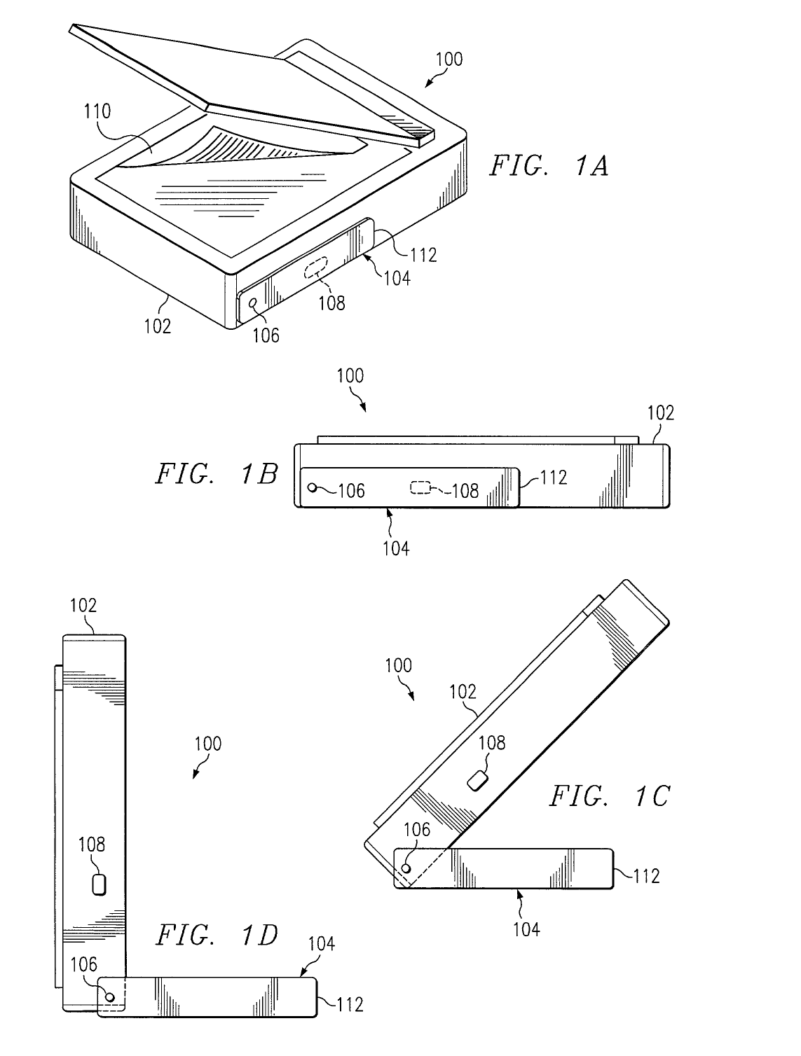

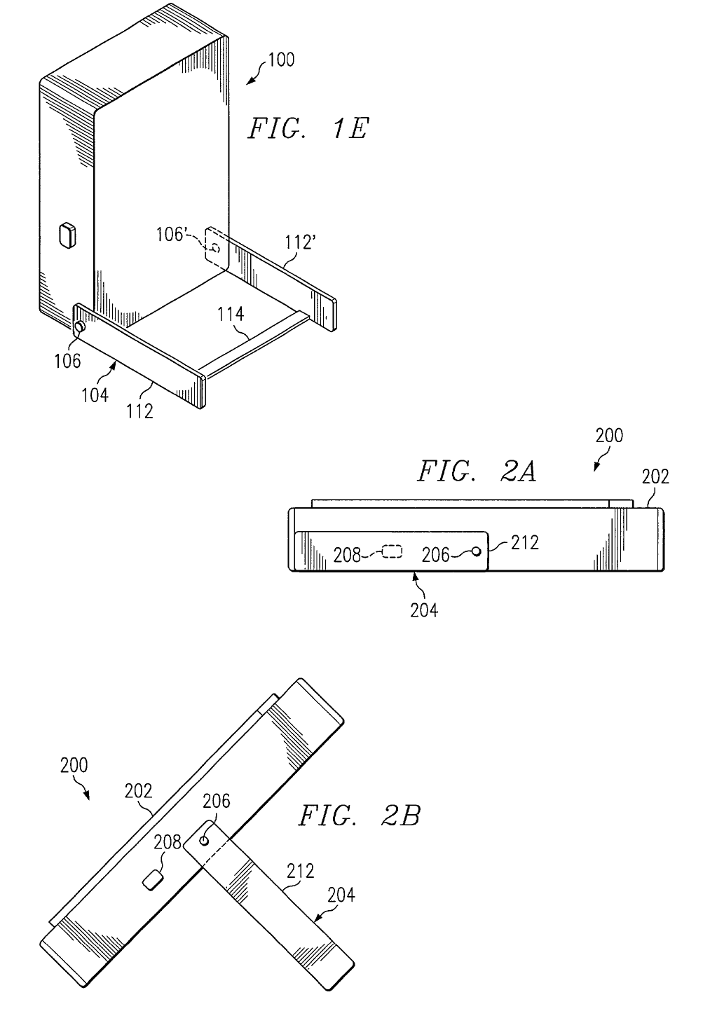

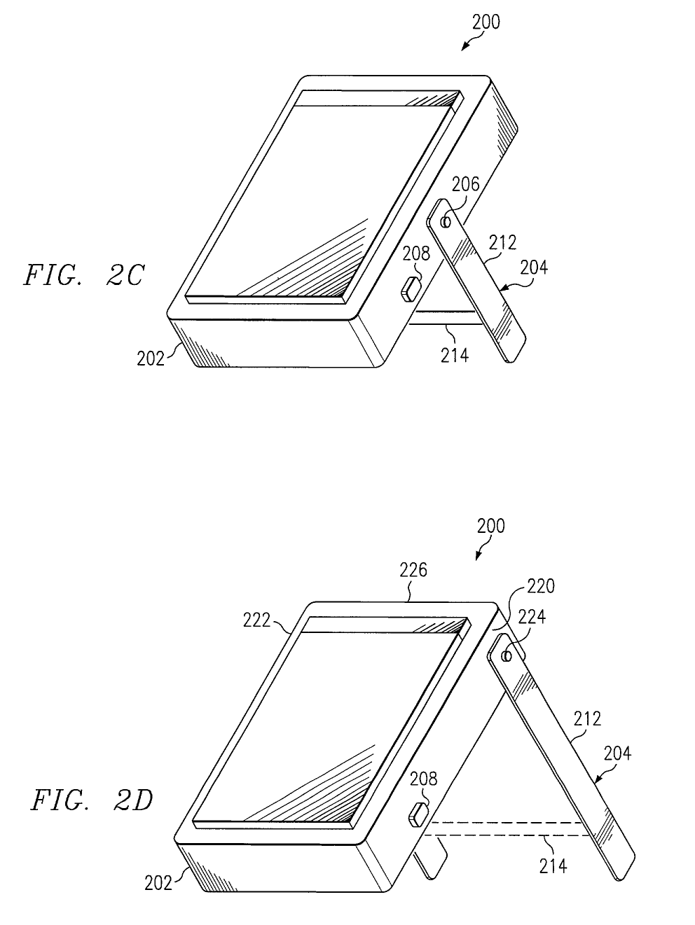

The preferred embodiment of the present invention and its advantages are best understood by referring to FIGS. 1 and 2 of the drawings.

An image capture device with a stand that facilitates storing of the image capture device in a raised position is disclosed. Preferably, when the image capture device is stored in such a manner, power to the device is automatically turned off by releasing a power switch disposed on the image capture device.

The present invention will be described herein with reference to a scanner. However, the invention is not so limited and contemplates the use of the teachings of the present invention with respect to other image capture devices, such as photocopiers, facsimile machines, printers and/or the like.

FIG. 1A-1E are different views of image capture device 100 according to a preferred embodiment of the present invention. As shown image capture device 100 comprises a scanner 102. Scanner 102 includes an imaging plate 110 on which an object to be scanned may be placed. Scanner 102 may be coupled to a computer system (not shown) to facilitate control of the scanner.

A carriage (not shown) that supports one or more scanning devices or subsystems, such as a light source, an internal optical system and a photosensitive device is disposed within scanner 102. The carriage is capable of moving along one or more support rails (not shown) disposed within scanner 102 along the length of scanner 102. As the carriage moves along the support rails, the light source radiates light that passes through imaging plate 110 and is reflected off the object placed thereon. The reflected light is collected by the internal optical system and directed onto the photosensitive device. The photosensitive device converts light reflected from the light source into one or more electrical signals.

Image capture device 100 also comprises a stand 104. Stand 104 includes a first arm 112 having a first end and a second end; a second arm 112′ having a first end and a second end; and a support member 114 (shown in FIG. 1E). In the embodiment illustrated in FIGS. 1A-1E, the first end of first arm 112 of stand 104 is pivotally coupled to scanner 102 at pivot 106. The first end of second arm 112′ of stand 104 is pivotally coupled to scanner 102 at pivot 106′. Pivots 106 and 106′ may be located at opposite corners of scanner 102. Preferably, the first end of first arm 112 and the first end of second arm 112′ are each coupled to the housing of scanner 102. A first end of support member 114 is disposed between the two ends of first arm 112 and a second end of support member 114 is disposed between the two ends of second arm 112′ thereby coupling the two arms 112 and 112′ to each other. First arm 112 and second arm 112′ are substantially parallel to each other.

Arms 112 and 112′ of stand 104 may be coupled to scanner 102 by any suitable means. For example, scanner 102 may have one or more holes and each of the arms 112 and 112′ of stand 104 may have one or more protrusions. Arms 112 and 112′ may be pivotally coupled to scanner 102 by interfacing the holes on scanner 102 and the protrusions on arms 112 and 112′ of stand 104. If desired, in alternative embodiments, scanner 102 may have one or more protrusions and arms 112 and 112′ of stand 104 may have one or more holes.

A power switch 108 may be disposed on the housing of scanner 102. Scanner 102 is preferably powered on when power switch 108 is in an engaged position. The position of power switch 108 on scanner 102 is selected such that when scanner 102 is in the horizontal position as shown in FIG. 1B, first arm 112 of stand 104 interfaces with power switch 108 such that power switch 108 is in the ON position and scanner 102 is powered on. When scanner 102 is in a raised position as shown in FIGS. 1C, 1D, or 1E, first arm 112 of stand 104 does not interface with power switch 108 and thus, in the raised position power switch 108 is in the OFF position and scanner 102 is powered off.

During use scanner 102 and the arms of stand 104 are preferably in the horizontal position. After a user finishes using the scanner, the scanner may be stored in a substantially vertical position as shown in FIG. 1D thereby saving space that would otherwise be occupied by the scanner. As the user lifts scanner 102 from one end, stand 104 remains in the horizontal position while scanner 102 pivots around pivots 106 and 106′. If desired, a support mechanism (not shown), such as a spring mechanism, may be coupled to scanner 102 to aid in lifting or lowering the scanner. As the scanner is being raised, power switch 108 is released. Thus, as shown in FIG. 1C, power switch 108 is no longer in the engaged position. The scanner is thus automatically switched off as it is being moved to the raised position. Therefore, a power save feature is provided by automatically switching off the scanner as the scanner is being moved into an upright or more substantially vertical orientation. The scanner is thus automatically switched off even if the user forgets to switch off the power to the scanner. The scanner may be stored in this position until the user desires to use the scanner at which point the scanner may be lowered to the horizontal position.

FIGS. 2A-2C are different views of image capture device 200 according to an alternative embodiment of the present invention. As shown image capture device 200 comprises a scanner 202 and a stand 204. Stand 204 includes a first arm 212 having a first end and a second end; a second arm (not shown) having a first end and a second end; and a support member 214. The first end of first arm 212 of stand 204 is pivotally coupled to scanner 202 at pivot 206. The first end of second arm is also pivotally coupled to scanner 202. The two pivots may be located on opposite sides of scanner 202. Preferably, the first end of first arm 212 and the first end of the second arm are each coupled to the housing of scanner 202, midway between two ends of scanner 202. However, the invention is not so limited and in alternative embodiments, the pivots may be located anywhere between the two ends of scanner 202. A first end of support member 214 is disposed between the two ends of first arm 212 and a second end of support member 214 is disposed between the two ends of the second arm thereby coupling the two arms to each other. The two arms of stand 204 are preferably substantially parallel to each other.

The two arms of stand 204 may be coupled to scanner 202 by any suitable means. For example, scanner 202 may have one or more holes, and each of the arms of stand 204 may have one or more protrusions. The arms of stand 204 may be pivotally coupled to scanner 202 by interfacing the holes on scanner 202 and the protrusions on the arms of stand 204. If desired, in alternative embodiments, scanner 202 may have one or more protrusions and the arms of stand 204 may have one or more slots.

A power switch 208 may be disposed on the housing of scanner 202. Scanner 202 is preferably powered on when power switch 208 is in an engaged or ON position. The position of power switch 208 is selected such that when scanner 202 is in the horizontal position as shown in FIG. 2A, first aim 212 of stand 204 interfaces with power switch 208 such that power switch 208 is in the ON position and scanner 202 is powered on. When scanner 202 is in a raised position as shown in FIGS. 2B, 2C or 2D, first arm 212 of stand 204 does not interface with power switch 208 and thus, in the raised position power switch 208 is in the OFF position and scanner 202 is powered off.

During use scanner 202 and the arms of stand 204 are preferably in the horizontal position. After a user finishes using the scanner, the scanner may be stored in the raised position as shown in FIGS. 2B, 2C or 2D. As shown in FIGS. 2B, 2C or 2D, scanner 202 and stand 204 are at an angle to each other. Preferably, stand 204 is spring loaded (not shown). Thus, when the user lifts scanner 202 from one end, stand 204 swings out and scanner 202 may be supported on stand 204. As stand 204 swings out, power switch 208 is preferably released. Thus, power switch 208 is no longer in the engaged position. The scanner is thus automatically switched off as it is being moved to the raised position. The scanner may be stored in this position until the user desires to use the scanner at which point the scanner may be lowered and stand 204 moved back to the horizontal position.

In the embodiment illustrated in FIG. 2D, scanner 202 is shown with the first end of first arm 212 coupled to side 220 of the housing of scanner 202 at pivot 224 and the first end of the second arm coupled to side 222 of the housing of scanner 202. When scanner 202 is in the raised position as illustrated in FIG. 2D, pivot 224 is at the upper end of scanner 202. If desired, stand 204 may comprise support member 214. If desired, in an alternative embodiment first arm and second arm of stand 204 may be coupled to side 226 of scanner 202. In this embodiment, stand 204 preferably does not comprise support member 214.

What is claimed is:

1. An improved image capture device, comprising:
an image capture device; and
a stand pivotally coupled to the image capture device, the stand operable to support the image capture device in a raised position.

2. The improved image capture device of claim 1, further comprising a power switch disposed on the image capture device such that when the image capture device and the stand are substantially horizontally oriented an arm of the stand engages the power switch to power the image capture device on.

3. The improved image capture device of claim 2, wherein the arm does not interface with the power switch when the image capture device is in a raised position.

4. The improved image capture device of claim 2, wherein when the image capture device is moved to a raised position the power switch is automatically released thereby switching the image capture device off.

5. The improved image capture device of claim 1, wherein the raised position is a substantially vertical position.

6. The improved image capture device of claim 1, wherein the raised position is a non-horizontal position.

7. The improved image capture device of claim 1, wherein the stand is operable to pivot from an initial position to a final position when the image capture device is raised from a first position to a second position.

8. The improved image capture device of claim 7, wherein the initial position for the stand is a horizontal position and the first position for the image capture device is a horizontal orientation.

9. The improved image capture device of claim 7, wherein the final position for the stand is a horizontal position and the second position for the image capture device is a substantially vertical position.

10. The improved image capture device of claim 8, wherein the final position for the stand and the second position for the image capture device is such that the stand and the image capture device are at an angle to each other.

11. The improved image capture device of claim 1, wherein the image capture device is selected from the group consisting of a scanner, a photocopier, a facsimile machine and a printer.

12. An improved image capture device, comprising:
an image capture device comprising a power switch; and
an image capture device stand pivotally coupled to the image capture device and operable to move from an initial position to a final position to support the image capture device in a raised position, the power switch being disposed on the image capture device such that when the image capture device is in a substantially horizontal position and the image capture device stand is in the initial position, the image capture device stand interfaces with the power switch to power the image capture device on.

13. The improved image capture device of claim 12, wherein the image capture device stand comprises:
a first arm pivotally coupled to a first side of the image capture device; and
a second arm pivotally coupled to a second side of the image capture device substantially opposite the first side.

14. The improved image capture device of claim 13, further comprising a support member coupled to the first arm and the second arm and operable to move the first arm and the second arm in tandem.

15. The improved image capture device of claim 13, wherein the first arm is coupled to a first comer of a first end of the image capture device and the second arm is coupled to a second comer of the first end of the image capture device, wherein the first comer is on the first side of the image capture device and the second comer is on the second side of the image capture device.

16. The improved image capture device of claim 13, wherein the first arm is coupled to the first side between two ends of the image capture device and the second arm is coupled to the second side between two ends of the image capture device.

17. The improved image capture device of claim 13, further comprising a support mechanism to facilitate movement of the image capture device between the horizontal position and the raised position.

18. The improved image capture device of claim 12, wherein the image capture device is selected from the group consisting of a scanner, a photocopier, a facsimile machine and a printer.

19. An improved image capture device, comprising:
an image capture device;
a stand pivotally coupled to the image capture device to facilitate storing of the image capture device in a raised position; and
a power switch disposed on the image capture device such that when the image capture device is not in the raised position the power switch is in an ON position due at least in part to at least a portion of the stand interfacing with the power switch.

20. The improved image capture device of claim 19, wherein the stand comprises:
a first arm, wherein an end region of the first arm is pivotally coupled to a first comer of a first end of the image capture device; and
a second arm, wherein an end region of the second arm is pivotally coupled to a second comer of the first end of the image capture device, wherein the first and second comers are on opposite sides of the image capture device.

21. The improved image capture device of claim 20, further comprising a support member having a first end and a second end, the first end of the support member coupled to the first arm and the second end of the support member coupled to the second arm, the support member operable to move the first arm and the second arm in tandem.

22. The improved image capture device of claim 19, wherein the image capture device is selected from the group consisting of a scanner, a photocopier, a facsimile machine and a printer.
